(19) United States
(12) Patent Application Publication
(10) Pub. No.: US 2011/0121596 A1
(43) Pub. Date: May 26, 2011

(54) MOTOR VEHICLE WITH MULTIFUNCTION BOX

(75) Inventor: Kurt BEYER, Wiesbaden (DE)

(73) Assignee: GM GLOBAL TECHNOLOGY OPERATIONS, INC., Detroit, MI (US)

(21) Appl. No.: 12/953,320

(22) Filed: Nov. 23, 2010

(30) Foreign Application Priority Data
Nov. 26, 2009 (DE) 102009055834.9

(51) Int. Cl. B60R 7/06

(52) U.S. Cl. 296/24.34; 296/37.8

(57) ABSTRACT

A motor vehicle storage device includes, but is not limited to at least one multifunction box, in particular for storing items during a journey with the motor vehicle. The multifunction box includes, but is not limited to a base body having at least one receiving compartment configured as a cooling compartment. An engagement device is provided for engagement in guide grooves of a rail system and are formed laterally on the base body in order to arrange and/or fix the base body in a crash-proof manner in the rail system free from tools.

### CROSS-REFERENCE TO RELATED APPLICATION

This application claims priority to German Patent Application No. 102009055834.9, filed Nov. 26, 2009, which is incorporated herein by reference in its entirety.

### TECHNICAL FIELD

The technical field relates to a multifunction box for a motor vehicle and more particularly to a multifunctional box for storing items during a journey with the motor vehicle. The technical field further relates to a storage device for a motor vehicle, in particular for a center console of a motor vehicle.

### BACKGROUND

Various multifunction boxes for motor vehicles are known from the prior art, which are provided in particular in a region of the center arm console of a motor vehicle. For example, known from DE 100 36 226 A1 is a cooling container for vehicles, which is disposed laterally adjacent to the seat cushion of a vehicle seat and whose cooling compartment is accessible from the top through a container opening after opening a lid, the cooling compartment being sufficient at least for accommodating a commercially available drinks bottle stored therein lengthways and having a depth significantly exceeding the bottle diameter. Furthermore, the cooling compartment is sufficient at least for accommodating a commercially available drinks bottle stored therein lengthways but is of a depth which is too small to accommodate the upright drinks bottle below the closed lid. Retaining means are disposed in the cooling compartment of the drinks container in order to secure the drinks bottle below the closed lid in a ready-to-hand storage position, in which the drinks bottle extends obliquely upward with its bottle neck toward an end region of the cooling compartment, which is arranged so that the bottle can readily be grasped. A lid arrangement is provided as the lid of the cooling container, by which means the drinks bottle protruding upwardly from the container opening is at least largely covered in a closed position.

In view of the foregoing, it is the object to equip a motor vehicle with a flexible multifunction box, wherein the multifunction box is arranged securely and removably. In particular, it is at least one object to provide a multifunction box with a cooling compartment, in which commercially available bottles can be accommodated on the multifunction box for cooling. In addition, other objects, desirable features and characteristics will become apparent from the subsequent summary and detailed description, and the appended claims, taken in conjunction with the accompanying drawings and this background.

### SUMMARY

A multifunction box is provided for a motor vehicle, in particular for storing items during a journey with the motor vehicle, comprising a base body having at least one receiving compartment configured as a cooling compartment. Engagement means are provided for engagement in guide grooves of a rail system are formed laterally on the base body in order to arrange and/or fix the base body in a crash-proof manner in the rail system free from tools.

Respectively one engagement means configured as a projection is disposed on the base body on its side facing the respective rail for mounting the base body in the rail pair that is disposed in a passenger compartment of a motor vehicle. The rails of the rail pair have guide grooves extending substantially horizontally on the mutually facing sides. The respective guide groove has a cross section that expands from the base of the groove. The respective projection correspondingly has a cross-section that expands toward the base body. The projection is preferably part of a bolt mounted displaceably on the base body. A spring preferably acts on the bolt, in particular in such a manner that its projection is pre-stressed with respect to the guide groove. The bolt can be moved from the guide groove against the force of the spring by means of an adjusting member mounted on the base body.

According to an embodiment, a bolt is thus displaceably mounted on the base body, on each of the two sides of the base body associated with the rail of the rail pair. This bolt has the projection. Under the action of the spring, the bolt is moved in the region of its projection toward the guide groove, thereby producing a frictional connection between base body and rail in the longitudinal extension of the guide groove. As a result of the configuration of the cross-section of the projection and the cross-section of the guide groove, a tight fit is obtained between projection and rail perpendicular to this. This requires a backlash-free mounting with the possibility of displacing the base body relative to the rails on overcoming the frictional connection. The prestress exerted via the spring is preferably determined so that the base body is not automatically displaced relative to the rails under the usual acceleration or braking forces acting in the motor vehicle. The displaceable mounting of the bolt then makes it possible to remove the base body perpendicularly to the plane connecting the rails or to mount it in the converse direction of motion when the bolts are completely inserted in the base body. It is therefore not necessary to displace the base body rearward to release this from the rail pair. The mounting of the base body in the rail pair can be accomplished in such a manner that the base body has two displaceable projections in relation to the longitudinal extension of the guide grooves, in the region of one end, which projections cooperate with the two rails, and also has two displaceable projections in the region of the other end, which cooperate with the two rails.

It is entirely feasible to provide the mounting only in one end region of the base body. In the other end region of the base body, the mounting can be accomplished in a different manner, in particular a mounting which permits a locking of the base body in the longitudinal direction of the rails. In the mounting, the centering of the base body of achieved by means of the particular cross-sectional shape of guide groove and projection. The projection is in particular configured as a truncated cone and the guide groove has a corresponding frustroconical cross-section. As a result of the cooperation of the bolt with its projection, the bolt having a circular cross-section, a linear contact takes place between projection and rail. With such a cross-sectional configuration, particularly favorable sliding properties are obtained between base body or its engagement means and rails. This is of particular advantage when means for locking base body and rails are additionally provided. Favorable sliding properties can be achieved in particular if the bolt is formed of plastic, in particular a polyoxymethylene plastic. The guide groove can also be provided with a surface which is optimized in regard to sliding properties. This preferably comprises an anodized surface. According to an embodiment, it is provided that the two bolts are arranged in alignment and the spring acts on the two bolts. In particular, the spring is configured as a helical compression spring, which is mounted in both bolts. In a structurally simple configuration, both bolts can thus be exposed to force and specifically to the same force so that substantially the same frictional forces are ensured between the projections disposed on both sides of the base body and the guide grooves. The displacement of the bolt against the force of the spring by means of the actuating member can be achieved in a particularly simple manner if the actuating member can be pivoted about a stationary axis of the base body by means of a manually actuatable actuating element, in particular an actuating handle. Preferably, two actuating members can be pivoted simultaneously by means of the actuating element so that the bolts can be moved synchronously. The movement of the bolt by means of the actuating member can be accomplished in a particularly simple manner if the actuating member has a lever arm, which engages in a groove of the bolt. If a tension spring additionally acts on both actuating members, it is not only ensured that the actuating members contact the bolt in a defined manner, in the sense of freedom from play and therefore noise reduction, but a superposition of the force of this tension spring with the prestressing force of the other spring which cooperates directly with the bolt can additionally take place.

In order to limit the maximum extension distance of the bolt, in particular from the aspect of the base body dismounted from the rail pair, it is expediently provided that the respective bolt is provided with a stop for limiting the movement of the bolt in the direction of the guide groove. This stop can comprise a securing ring connected to the bolt or, in particular in the case of a bolt comprising plastic, the stop is directly part of the bolt. The mounting according to the invention is used in particular in a rail pair in which the respective rail is bent and is mounted in the region of one end in the floor of the motor vehicle and in the region of the other end in the floor or in the instrument panel of the motor vehicle. The rail has a guide groove in an upper region running substantially horizontally. In particular for manufacturing reasons, this can be open in the region of one end, in particular the rear end. However, this is not necessary. According to an embodiment, means for locked mounting of the base body in the rail pair are provided. The respective bolt is displaceable from the housing by means of spring force and the respective bolt displaceably receives the means for locking that is configured as a locking pin. The guide groove facing this locking pin has at least one recess for receiving the locking pin. Furthermore, the locking pin is prestressed by means of spring force in the direction of this guide groove and the locking pin is displaceable in its longitudinal directions by means of an actuating member mounted in the base body, and this locking pin is provided with a stop, which contacts the bolt during displacement of the locking pin into the base body. By this means, on the one hand, a secure locking of base body and rail is achieved, on the other hand, easy dismounting and mounting of base body and rail pair is possible.

Such a mounting of a base body in a rail pair allows a vertical insertion or removal of the base body into or from the rail pair. Furthermore, the base body can be positively connected to the rail pair. In the locking function, the base body is positively fixed in the rail pair. If the locking function is released, the base body can be moved freely as a result of the cooperation of the projections with the guide grooves of the rails. In the removal function, the locking pins and the bolts, therefore the locking pins and the projections are moved so far from the guide grooves of the rails that the base body can be removed vertically. This mounting allows easy, appropriate one-handed operation for unlocking and displacing the base body.

In addition, the base body can be mounted ergonomically favorably. In order to cancel the locking function, on actuating an actuating handle, the locking pins are preferably moved inward against the force of a spring inside the bolt from the recesses of the rails so that a displacement of the base body inside the guide grooves of the rails becomes possible. After releasing the actuating handle, the spring, in particular by means of levers, draws the locking pins back into their initial position. The base body is consequently positively locked with the rail. In order to remove the base body, the actuating handle is preferably moved beyond the position which allows displacement of the base body, therefore into the locking function. In so doing, in particular levers actuate the locking pins and pull the bolts with the projections over a stop against the force of a spring so far into the interior of the base body that it becomes possible to remove the base body. The insertion or mounting of the base body is accomplished in the reverse order. A spring presses the bolts with their projections back into their initial position as far as a stop.

The function of the two-stage actuation is preferably designed in such a manner that the operator perceives a perceptible increase in force between the locking function and the removal function. Pulling the bolt back too far and therefore accidentally removing the base body is thereby prevented. For this reason, an optimal matching of the force of the spring acting on the locking pins and the force acting on the bolts is required.

In addition, an acoustic or haptic signal, for example, a gentle snapping-in, can also be provided as further security against incorrect operation. Usually, the mounting of the base body in the rail pair will take place in such a manner that, in relation to the longitudinal extension of the guide grooves, the base body has two displaceable projections in the region of one end which cooperate with the two ends, and also has two displaceable projections in the region of the other end, which cooperate with the two rails. It is sufficient to merely provide the locking of the base body in one end region of the base body. In the other region of the base body, the mounting can be restricted to an exclusive sliding mounting in the guide grooves, without locking, with the possibility for mounting or dismounting the base body by inserting or retracting the bolt. The respective bolt in particular has a stop for limiting the retraction movement of the bolt by abutment of the stop in the housing of the base body. If the base body is mounted and the respective projection contacts the guide groove, the bolt does not yet abut with its stop against the housing. If the base body is dismounted, the bolt can only retract slightly more widely from the housing. In particular, the locking pin is displaceably mounted concentrically to the bolt in a through-hole of the bolt.

The locking pin can be moved between a position in which the end of the locking pin facing away from the base body is completely inserted into the bolt and a position in which this end of the locking pin is withdrawn from the bolt, for locking with the rail. In particular, the locking pin has a circular cross-section and the respective recess has a slightly larger circular cross-section for receiving the locking pin. During insertion of the locking pin, its stop reaches the bolt and thereby accordingly entrains the bolt during further insertion, whereby both the locking pin and also the bolt can be transferred into an inserted position in which the base body can be dismounted so that the base body can be removed vertically.

The two actuating members can preferably be pivoted simultaneously by means of the actuating element, in the actuating handle, for displacing the two locking pins and a tension spring, in particular a helical tension spring, acts on both actuating members. This tension spring consequently acts on the locking pins in the sense of a restoring movement for transferring the locking pins into their locking position. The respective actuating member is consequently prestressed with respect to the locking pin by means of the spring, and specifically in a prestressing direction, which corresponds to the prestressing direction of the respective bolt under the action of its associated spring.

The adjusting force can be introduced particularly simply into the locking pin if the respective adjusting member has a lever arm which engages in a recess of the locking pin. The end of the bolt facing the guide groove is in particular provided with a radial recess, through which the stop on the locking pin passes. By this means, the entraining function between locking pin and bolt can be accomplished structurally in a particularly simple manner. The respective rail is preferably provided in the region of the guide groove with a plurality of recesses disposed in the longitudinal direction of the guide groove in order to be able to lock the base body in different longitudinal positions of the rail with this.

In an embodiment, it is accordingly provided that the engagement means are configured as retractable/extendible engagement means in order to ensure a reduced-resistance withdrawal from and insertion of the multifunction box into the rail system. In another embodiment, for removal the engagement means can be inserted so far that the engagement means can be brought completely out of engagement with the rail system. In other embodiments, an engagement depth is merely reduced by an insertion of the engagement means so that a resistance against any removal needs to be overcome. A front end of the engagement means, which is preferably aligned adjacent to the rails, therefore preferably, has a round section. In one embodiment, a sphere or another sliding or rolling body is disposed at the tip of the engagement means.

In another embodiment, it is provided that the multifunction box is configured to be case-like. A configuration having two principal extensions in two principal directions of extension and an auxiliary extension in an auxiliary direction of extension is designed as a case-like configuration. The auxiliary direction of extension is preferably defined by a spacing of the rails.

In yet another embodiment, it is provided that a receiving compartment is configured centrally in the base body as a main receiving compartment, which is open at the top, for storing larger items.

A further embodiment in turn provides that an auxiliary receiving compartment is formed on at least one of the narrow sides. A receiving compartment provided adjacent to the main receiving compartment is designated as an auxiliary receiving compartment.

In yet another embodiment, it is provided that at least one of the auxiliary receiving compartments is configured as a cooling compartment. In other embodiments, at least one auxiliary compartment without a cooling function is provided. The auxiliary receiving compartments and/or the main receiving compartment are preferably configured such that the size is adapted to the cooling of specific items such as commercially available drinks bottles and/or medicinal products. Efficient utilization of the refrigeration is possible due to the adaptation of the cooling compartment size to specific items.

In addition, a further embodiment provides that at least one lid element is provided for closing at least one of the receiving compartments.

In a further embodiment, it is provided that at least one handle element is provided for taking out or carrying the multifunction box. In a preferred embodiment, the handle element is coupled to the engagement means.

The embodiments further includes a storage device for a motor vehicle, in particular for a center console of a motor vehicle, which includes a two-rail rail system with corresponding guide grooves and at least one multifunction box that can be brought into engagement with the rail system via the guide grooves and corresponding engagement means between the rails are provided. The embodiments additionally include a motor vehicle having at least one storage device according to the embodiments.

### BRIEF DESCRIPTION OF THE DRAWINGS

The present invention will hereinafter be described in conjunction with the following drawing figures, wherein like numerals denote like elements, and:

FIG. 1 shows schematically in a perspective view a section of a motor vehicle in the region of a center arm console with a cockpit region, a rail system, and a multifunction box in an opened state;

FIG. 2 shows schematically in another perspective view another embodiment of a multifunction box in the closed state;

FIG. 3 shows schematically in another perspective view the multifunction box from FIG. 2;

FIG. 4 shows schematically in a further perspective view the multifunction box from FIG. 2 in an opened state;

FIG. 5 shows schematically in a perspective view a section of the multifunction box from FIG. 2;

FIG. 6 shows schematically in a perspective view a further embodiment of the multifunction box with a different lid concept;

FIG. 7 shows schematically in a perspective view the multifunction box from FIG. 6 in a different arrangement;

FIG. 8 shows schematically in a perspective view the multifunction box from FIG. 6 in another arrangement;

FIG. 9 shows schematically in a perspective view a section of the multifunction box from FIG. 8;

FIG. 10 shows schematically in a perspective view a further embodiment of the multifunction box with handle and a further lid concept;

FIG. 11 shows schematically in a perspective view the multifunction box from FIG. 10 in another arrangement;

FIG. 12 shows schematically in a perspective view the multifunction box from FIG. 10 in another arrangement;

FIG. 13 shows schematically in another perspective view the multifunction box from FIG. 10;

FIG. 14 shows schematically in a perspective view the multifunction box from FIG. 10 in another arrangement;

FIG. 15 shows schematically in a perspective view a further embodiment of the multifunction box with cooling compartment;

FIG. 16 shows schematically in a perspective view the multifunction box from FIG. 15 in the closed state with handle;

FIG. 17 shows schematically in a perspective view the multifunction box from FIG. 16 without handle;

FIG. 18 shows schematically in another perspective view the multifunction box from FIG. 15;

FIG. 19 shows schematically in another perspective view the multifunction box with an opened compartment;

FIG. 20 shows schematically in a perspective view a further embodiment of the multifunction box with a further lid concept;

FIG. 21 shows schematically in a perspective view a section of the front region of the multifunction box from FIG. 20;

FIG. 22 shows schematically in a perspective view the multifunction box from FIG. 20 with closed lid;

FIG. 23 shows schematically in another perspective view a section of the multifunction box from FIG. 20;

FIG. 24 shows schematically in a perspective view a further embodiment of the multifunction box with integrated armrest; and

FIG. 25 shows schematically in another perspective view the multifunction box from FIG. 24.

### DETAILED DESCRIPTION

The following detailed description is merely exemplary in nature and is not intended to limit application and uses. Furthermore, there is no intention to be bound by any theory presented in the preceding background or summary or the following detailed description.

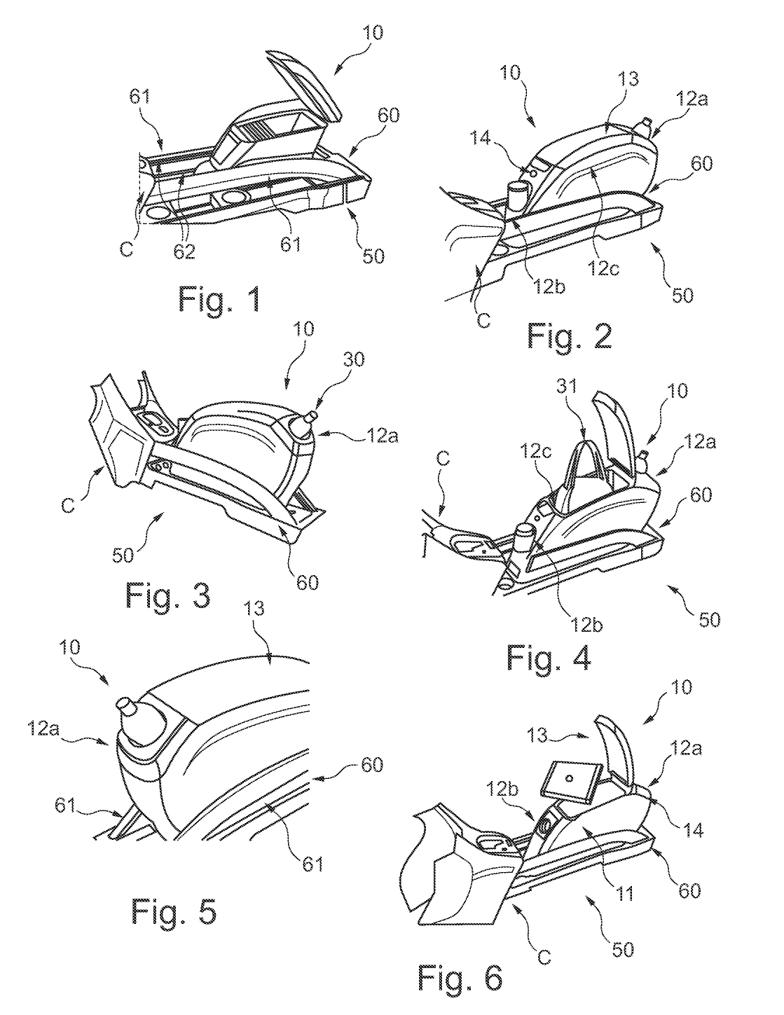

FIG. 1 to FIG. 25 show configurations of a multifunction box 10 for a storage device 50 comprising a rail system 60 of a motor vehicle in various embodiments. The multifunction box 10 is configured for the secure storage of items during a journey with the motor vehicle and has a base body 11, which functions as a housing. A plurality of receiving compartments 12 are formed in and on the base body 11. The receiving compartments 12 are configured differently in regard to their function and form, according to the embodiment. Engagement means for engagement in guide grooves 62 of the rail system 60 are formed laterally on the base body 11 in order to dispose and/or fix the base body 11 in a crash-proof manner in the rail system 60. Fixing and/or removal without tools is possible in this case.

The rail system 60 is located in a center console compartment in a motor vehicle and extends in a curved manner beginning from a rear-side floor region with increasing distance from the floor region in an arcuate manner in the vertical direction toward a cockpit region C. In the region adjacent to the cockpit region C, the rail system 60 runs approximately parallel to the floor region in the vertical direction. The rail system 60 comprises two suitably curved rails 61 running parallel to one another at a distance. The rails 61 each have two guide grooves or guide groves 62 (or tracks) on their mutually facing sides. The guide grooves 62 of one rail 61 are disposed such that these each correspond to a guide groove 62 of the second rail 61. A distance of the rails 61 from one another corresponds to a width of the multifunction box 10, which is disposed between the rails 61 in the rail system 60.

The engagement means are accordingly configured to correspond to the guide grooves 62 for a tool-free and crash-proof arrangement of the multifunction box 10 in the rail system 60. The engagement means for an arrangement of the multifunction box 10 between the rails 61 project laterally, that is in a width direction of the multifunction box in an arrangement between the rails 61. The engagement means are configured to correspond to the guide grooves 62 in regard to their shape and serve as sliding blocks. Further, the engagement means are configured to be at least partially retractable so that an overall width of the multifunction box 10 is variable for removal. The engagement means protruding laterally from the lid device are retractable so that the multifunction box 10 can be inserted and removed from between the rails 61, in particular transversely to the course of the rails. For this purpose, a corresponding mechanism is provided, which retracts or extends the engagement elements laterally at least in part. In other embodiments, the engagement means are configured to be resilient so that these can be removed laterally from the guide grooves or inserted into these guide grooves by suitable bending. In order to arrange the multifunction box in a crash-proof manner between the rails, the engagement means can be appropriately locked onto the rails 61, for example, in corresponding locking apertures or by corresponding stops or movement limiters. The locking means are, for example, configured to be adjustable.

The multifunction box has at least one receiving compartment 12, preferably a plurality of receiving compartments. One receiving compartment 12 is configured as a cooling compartment 12a. Accordingly, the cooling compartment 12a has sections for cooling elements, for example, for cooling storage batteries, fans, or the like. A power connection is provided in the multifunction box for supplying power to the cooling elements.

In one exemplary embodiment according to FIG. 2, the cooling compartment 12a is formed on a rear-side back region of the multifunction box 10. The cooling compartment 12a in FIG. 2 has no lid so that a drinks bottle 30 disposed therein projects from the cooling compartment 12a. When the cooling element is switched off, the cooling compartment 12a functions as a drinks bottle holder. A beverage can holding compartment 12b is formed on a front side, i.e., on a side of the multifunction box facing the cockpit C. The beverage can holding compartment 12b is not configured as a cooling compartment but in other embodiments, can be configured as a cooling compartment. Located approximately centrally in the base body 11 is a storage compartment 12c, which is configured to be as large as possible for receiving many and/or large items. The storage compartment 12c has an upwardly directed access opening, which can be closed by means of a lid 13. In order to configure the storage compartment 12c to be burglar-resistant or burglar-proof, a closure device 14 is provided in the multifunction box 10.

The arrangement of the multifunction box 10 according to FIG. 2 in the rail system 60 is shown from a different perspective in FIG. 3. FIG. 4 shows the multifunction box 10 according to FIG. 2, where the lid 13 of the storage compartment 12c is open. A handbag 31 is disposed in the storage compartment 12c. This shows that in the exemplary embodiment shown, the storage compartment 12c is of a sufficient size to hold the handbag 31.

FIG. 5 shows a section of the cooling compartment 12a of the multifunction box 10 according to FIG. 2. The cooling compartment 12a is aligned approximately obliquely to a vertical so that the drinks bottle 30 disposed in the cooling compartment 12a projects rearwardly upward. In this way, the cooling compartment 12a is readily accessible from a rear region or a back region.

FIG. 6 to FIG. 9 show another embodiment of the multifunction box 10. In the embodiment according to FIG. 6 to FIG. 9, the cooling compartment 12a is configured to be closeable with a lid 14. The storage compartment 12c and the beverage can holding compartment 12b are designed in a somewhat more space-saving manner in favor of a larger cooling compartment 12a. The beverage can holding compartment 12b is configured as a foldable cup holder, which can be folded out. In a folded-in position, the cup holder abuts approximately vertically against the base body 11. In the folded-out position the cup holder projects substantially horizontally from the base body 11. The cup holder is configured to be approximately plate-shaped with an edge and a recess for securely receiving a cup or the like during a journey with the motor vehicle.

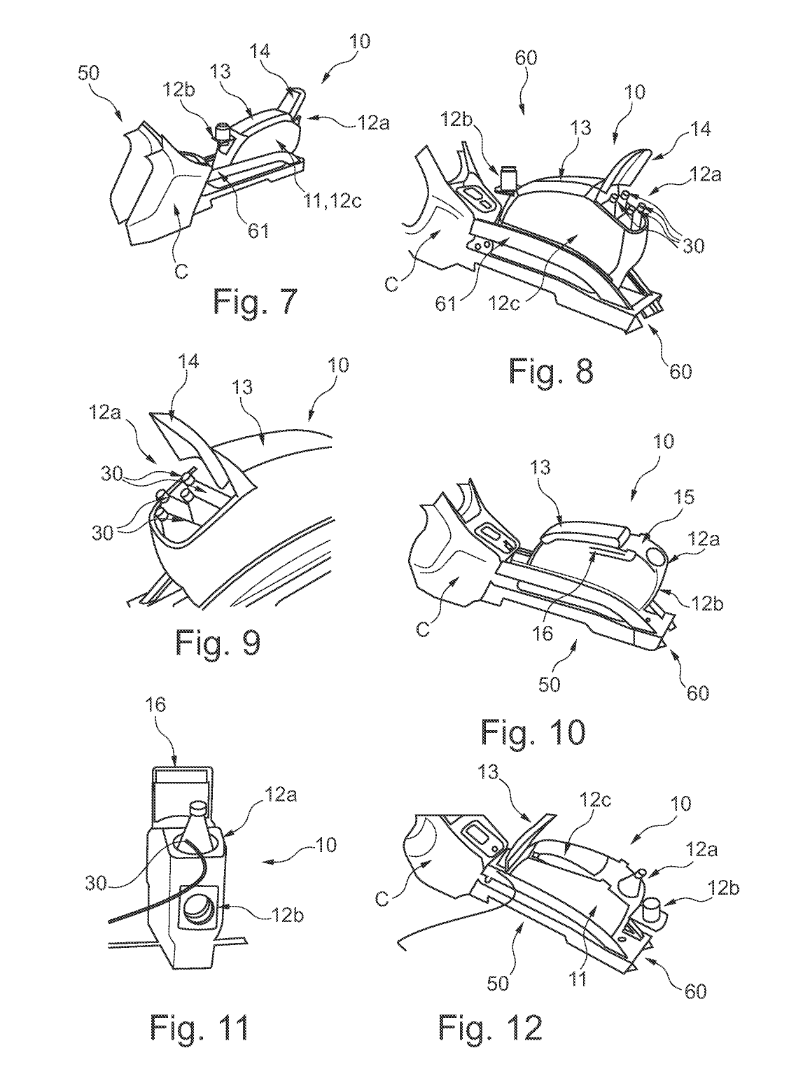

FIG. 7 shows the multifunction box 10 according to FIG. 6 with open lid 14, closed lid 13, and folded-out cup holder. FIG. 8 shows the storage device 50 from FIG. 7 from a different perspective. It can be clearly identified in FIG. 8 that the cooling compartment 12a is configured to be larger compared with the exemplary embodiment according to FIG. 2 to FIG. 5 since four bottles 30 can now be received in the cooling compartment 12a. FIG. 9 shows the section around the cooling compartment from FIG. 8 more clearly. The lids 13 and 14 adjoin one another approximately at their connecting regions with the base body 11 and end flush with one another. In this way, a visually pleasing impression is produced on a lid side of the multifunction box. Both lids are attached to the base body 11 so that they can be folded upward by means of a hinge joint and specifically in opposite directions.

FIG. 10 to FIG. 14 show another embodiment of the multifunction box 10 with a different lid 13 and a handle 15. According to the exemplary embodiment shown in FIG. 10 to FIG. 14, the lid 13 of the storage compartment 12c is configured to be displaceable forward. In the embodiment according to FIG. 10 to FIG. 14, the beverage can holding compartment 12b was therefore moved into the back region to the cooling compartment 12a, so that on opening the lid 13, no impairments arise. The lid 13 is additionally provided with upholstery and therefore functions simultaneous as an arm rest. A foldable handle 15 is provided on the base body 11. The handle 15 can be folded upward via lateral pivot points 16 so that it protrudes from the base body 11 as shown in FIG. 11. In a rest position, the handle 15 rests on the base body 11. The back region of the multifunction box 10 can be seen in FIG. 11. The beverage can holding compartment 12b formed from the fold-out cup holder and the cooling compartment 12a is provided here. The multifunction box 10 can be removed completely from the rail system 60 so that this can also be used alone and can be moved with a user like a suitcase. In this embodiment, the cooling compartment 12a cannot be closed with a lid 14. Merely a storage compartment 12c can be closed with the lid 13.

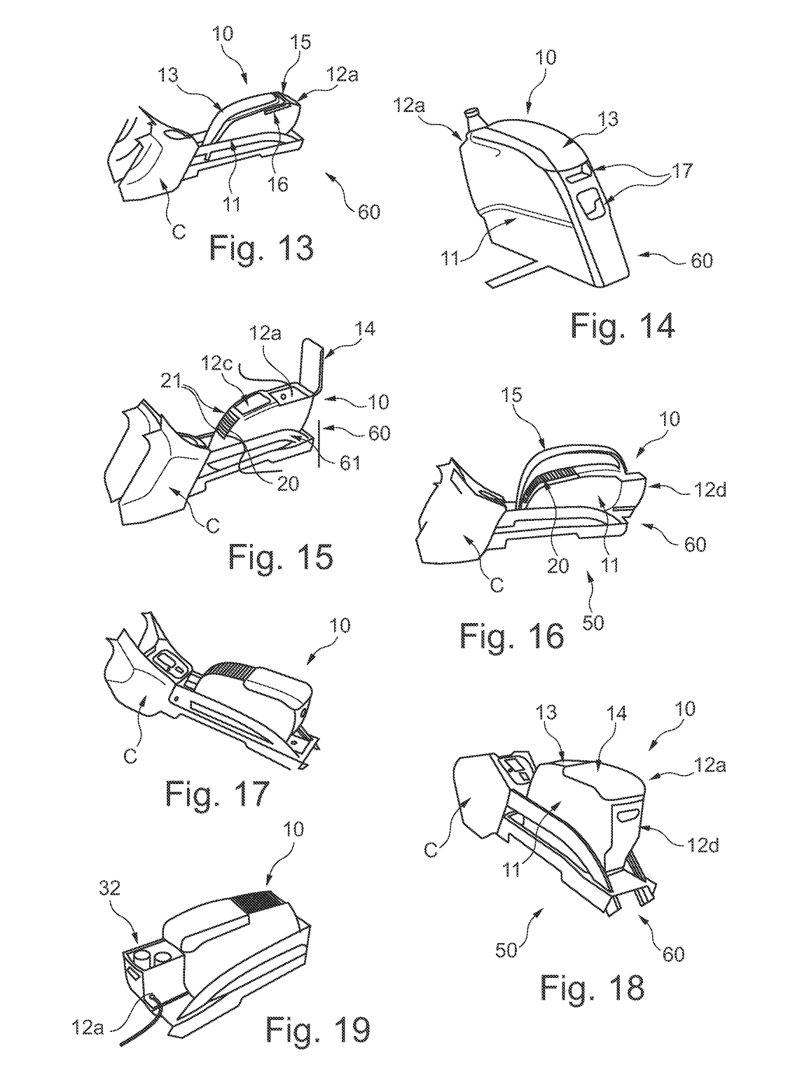

FIG. 12 shows the multifunction box 10 with open lid 13. It can be clearly seen how the lid 13 is displaced forwardly downward for opening along the base body 11 and projects upward from the base body 11. Access to the storage compartment 12c is released by this means. FIG. 13 shows the multifunction box 10 with closed lid 13 and retracted handle 15. It can be clearly seen here that the handle does not project and nestles against the base body 11 in the folded-in position. FIG. 14 shows the multifunction box from FIG. 13 in another perspective. Grip elements 17 for opening the lid and for removing the multifunction box 10 from the rail system 60 are provided on the front region. One of the grip elements is at the same time configured with a locking function, which effects a locking with the base body 11 when closing the lid 13. For opening the lid 13 it is firstly necessary to actuate the handle element to cancel the locking. Only thereafter can the lid 13 be moved in accordance with an opening movement.

FIG. 15 to FIG. 19 show yet another embodiment of the multifunction box 10. The lid 13 is configured so that it can be moved together as a roller-blind-like cover device 20 and to this end has a plurality of slats 21 arranged in order in a longitudinal direction or direction of extension of the rail system 60. The slats 21 extend substantially in a transverse direction so that this can be guided between guide grooves in the base body 11. For guidance of the cover device 20 between and on the base body 11 the slats 21 have corresponding guide elements that correspond to the guide grooves in the base body 11. In one configuration, the guide elements are configured to be at least partially of variable length so that an overall width of the cover device 20 is variable and the cover device 20 can be inserted and removed between the guide grooves of the base body, in particular in the transverse or width direction. For this purpose a corresponding mechanism is provided, which laterally retracts the guide elements at least in part. In other embodiments the guide elements are configured to be resilient so that these can be removed laterally from the guide grooves of the base body 11 or inserted by suitable bending. The slats 21 can be made of any material. In one embodiment, the slats 21 are made of an aluminum material.

In other embodiments, the slats 21 are made of a plastic material. Again, other embodiments provide that the slats 21 are made of a textile material. Individual slats 21 can be made with different materials. Preferably opaque materials are used for the manufacture. Burglar-proof materials are further preferably used. In one exemplary embodiment, the slats 21 are differently shaped. In addition, the cover device 20 is configured to be closable. That is, the cover device 20 has a closure element which can be brought into engagement with a corresponding closure element on the cockpit region C and/or on the base body 11 and implements a burglar-resistant or burglar-proof function.

In the embodiment according to FIG. 15 to FIG. 19, the lid 14 is provided for closing the cooling compartment 12a. As can be seen from FIG. 16, a handle 15 is provided on the multifunction box 10. The handle 15 spans the multifunction box 10 in the longitudinal direction. The handle 15 is configured to be detachable for flexible handling of the multifunction box 10. In FIG. 17 to FIG. 19 the handle 15 is removed from the multifunction box 10. FIG. 17 shows the multifunction box from FIG. 15 in a different perspective and with closed lids 13, 14. FIG. 18 shows the multifunction box 10 in a further perspective with a view to the rear part of the multifunction box 10. As can be identified in conjunction with FIG. 16, the cooling compartment 12a is configured as a drawer. This can be inserted and retracted accordingly. FIG. 19 shows the cooling compartment 12a in a retracted position in a different perspective, beverage cans 32 disposed in the cooling compartment 12a being visible.

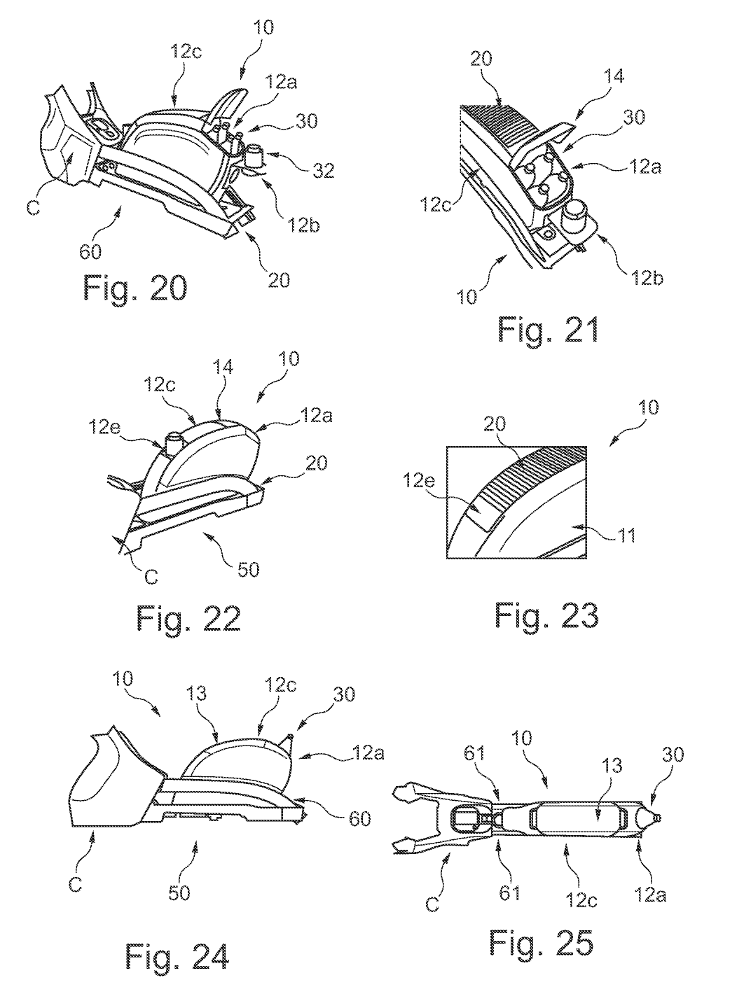

FIG. 20 to FIG. 23 show yet another embodiment. The embodiment according to FIG. 20 to FIG. 23 has the cover device 20 according to the embodiment from FIG. 15 to FIG. 19 as the cover device 20. In addition, the beverage can holding compartment 12b is formed in the back region on the cooling compartment 12a. The beverage can holding compartment 12b is configured as a fold-in cup holder according to the embodiment from FIG. 6 to FIG. 9. The cooling compartment 12a is configured with the lid 14 as a closed cooling compartment 12a. In addition, as can be seen in FIG. 22 and FIG. 23, a further cup holder 12e is formed at the front on the storage compartment 12c. The cup holder 12e is configured so that it can be concealed with the cover device 20 so that this cannot be identified from outside when the cover device 20 is pulled down.

FIG. 24 and FIG. 25 finally show another embodiment of a multifunction box 10. The lid 13 of the storage compartment 12c of the multifunction box 10 adjoins flush with the base body 11. The cooling compartment 12a is formed in the back region of the multifunction box 10. The cooling compartment 12a is formed without a lid 14 and serves as a cooling bottle holder. FIG. 25 shows the multifunction box 10 from above. The narrow form of the multifunction box 10, which is disposed between the two rails 61 spaced apart in the transverse direction, can be clearly seen.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A multifunction box for a motor vehicle, comprising:
a receiving compartment configured as a cooling compartment;
a base body comprising the receiving compartment;
an engagement device adapted to engage guide grooves of a rail system formed laterally on the base body and adapted to arrange the base body in the rail system.

2. The multifunction box according to claim 1, wherein the engagement device is retractable/extendible and adapted to provide a reduced-resistance between the multifunction box and the rail system.

3. The multifunction box according to claim 1, wherein the multifunction box is a case-like box.

4. The multifunction box according to claim 1, wherein the receiving compartment is configured as a main receiving compartment centrally in the base body that is open at a top.

5. The multifunction box according to claim 1, further comprising an auxiliary receiving compartment formed on at least one narrow side.

6. The multifunction box according claim 5, wherein the auxiliary receiving compartment is configured as an auxiliary cooling compartment.

7. The multifunction box according to claim 1, further comprising a lid element adapted to close the receiving compartment.

8. The multifunction box according to claim 1, further comprising a handle element coupled to the multifunction box.

9. A console for a motor vehicle, comprising:
a two-rail rail system comprising a first rail and a second rail;
guide grooves corresponding to the two-rail rail system; and
a multifunction box adapted for engagement with the two-rail rail system via the guide grooves, the multifunction box comprising:
a receiving compartment configured as a cooling compartment;
a base body comprising the receiving compartment; and
an engagement device between the first rail and the second rail that is adapted to engage the guide grooves formed laterally on the base body and adapted to arrange the base body in the two-rail rail system.

10. The console according to claim 9, wherein the console is a center console.

11. The console according to claim 9, wherein the engagement device is retractable/extendible and adapted to provide a reduced-resistance between the multifunction box and the two-rail rail system.

12. The console according to claim 9, wherein the multifunction box is a case-like box.

13. The console according to claim 9, wherein the receiving compartment is configured as a main receiving compartment centrally in the base body that is open at a top.

14. The console according to claim 9, further comprising an auxiliary receiving compartment formed on at least one narrow side.

15. The console according claim 14, wherein the auxiliary receiving compartment is configured as an auxiliary cooling compartment.

16. The console according to claim 9, further comprising a lid element adapted to close the receiving compartment.

17. The console according to claim 9, further comprising a handle element coupled to the multifunction box.
